(19) United States
(12) Patent Application Publication
(10) Pub. No.: US 2019/0065681 A1
(43) Pub. Date: Feb. 28, 2019

(54) SYSTEM AND METHODS FOR MEDICAL DEVICE ASSET MANAGEMENT VIA DISTRIBUTED LEDGERS

(71) Applicant: Timotheus Anton GMEINER, Toronto (CA)

(72) Inventor: Timotheus Anton GMEINER, Toronto (CA)

(21) Appl. No.: 15/687,609

(22) Filed: Aug. 28, 2017

(51) Int. Cl. G06F 19/00

(52) U.S. Cl. CPC G06F 19/321; G06Q 30/04; G06F 19/328

(57) ABSTRACT

A system and methods for managing a plurality of medical equipment via distributed ledgers involving: a network device configured to communicate with the plurality of medical equipment; a mobile application storable in relation to, and configuring, each piece of medical equipment of the plurality of medical equipment to individually communicate with the network device, the mobile application comprising a set of executable instructions for automatically collecting usage data in relation to each piece of medical equipment of the plurality of medical equipment and for automatically transmitting the usage data to the network device; and a processor configured to receive the usage data from the network device and to generate billing data based on the usage data corresponding to each piece of medical equipment of the plurality of medical equipment.

### TECHNICAL FIELD

Generally, the present disclosure technically relates to contract systems and methods. More particularly, the present disclosure technically relates to electronic contract systems and methods. Even more particularly, the present disclosure technically relates to smart contract systems and methods for use in managing capital medical equipment.

### BACKGROUND

In the related art, a focus on privacy compliance has traditionally constrained development of improved systems for “Electronic Health Records” (EHRs). The related art faces challenges, such as personalization and data science issues, in health record systems which discourages patients' engagement in the details of their own healthcare and to provide a reliable and secure agency in relation to the medical data. In the related art, a decentralized medical record management system for handling EHRs, using blockchain technology, has been proposed which provides patients with an immutable log and access to their medical information across healthcare service providers and healthcare treatment sites. Using blockchain properties, this related art EHR system manages authentication, confidentiality, accountability, and data sharing. Modular software systems are integrated with a healthcare provider's existing, local data storage systems.

In the related art, blockchain technology involves a distributed database that maintains a continuously growing list of records, called blocks. Each block has a timestamp and a link to a previous block. A blockchain is typically managed by a peer-to-peer network collectively adhering to a protocol for validating new blocks. Blockchains are inherently resistant to modification of the data. Once recorded, the data in any given block cannot be altered retroactively without the alteration of all subsequent blocks and a collusion of the network majority. Functionally, a blockchain serves as an open distributed ledger that can record transactions between two parties efficiently and in a verifiable and permanent way. The ledger itself is programmable for automatically triggering transactions.

In the related art, blockchains are secure distributed computing systems with high “Byzantine fault tolerance” (BFT). Decentralized consensus is achieved via using a blockchain. In fault-tolerant computer systems, and, in particular, distributed computing systems, a BFT is a characteristic that tolerates a class of failures referred to as the “Byzantine Generals' Problem,” wherein the Byzantine Generals' Problem is a generalized version of the “Two Generals' Problem” corresponding to an unsolvability proof. The phrases “interactive consistency,” “source congruency,” “error avalanche,” “Byzantine agreement problem,” “Byzantine generals problem,” and “Byzantine failure” also refer to BFT. Byzantine failures are considered the most general and most difficult class of failures among the failure modes. The so-called fail-stop failure mode occupies the simplest end of the spectrum. Whereas a fail-stop failure model assumes that the only way to fail is via a node crash that is detected by other nodes, a Byzantine failure has no restrictions. As such, in a Byzantine failure, the failed node can generate arbitrary data, masquerading as “correct” data, thereby rendering fault tolerance difficult.

These related art systems and methods have experienced many challenges, including the ability to provide an electronic system for managing capital equipment, such as medical capital equipment. Therefore, a need exists for a smart contract system and methods that can manage medical capital equipment.

### SUMMARY

In addressing at least many of the challenges experienced in the related art, the subject matter of the present disclosure involves a system and methods for medical device asset management via distributed ledgers, e.g., a smart system and methods for electronically managing medical capital equipment, such as magnetic resonance imaging (MRI) equipment, e.g., in relation to leasing medical capital equipment, pay-per-use, and/or pay-per-scan, thereof. An MRI machine is large capital expense for both public and private facilities. Payment for medical imaging services in countries, such as the United States of America, is facilitated through Medicare Fiscal Intermediaries (FIs). The smart contract system and methods of the present disclosure facilitate communication of payment and related information.

In accordance with an embodiment of the present disclosure, a system for managing a plurality of medical equipment via distributed ledgers comprises: a network device configured to communicate with the plurality of medical equipment; a mobile application storable in relation to, and configuring, each piece of medical equipment of the plurality of medical equipment to individually communicate with the network device, the mobile application comprising a set of executable instructions for automatically collecting usage data in relation to each piece of medical equipment of the plurality of medical equipment and for automatically transmitting the usage data to the network device; and a processor configured to receive the usage data from the network device and to generate billing data based on the usage data corresponding to each piece of medical equipment of the plurality of medical equipment.

In accordance with an embodiment of the present disclosure, a method of providing a system for managing a plurality of medical equipment via distributed ledgers comprises: providing a network device configured to communicate with the plurality of medical equipment; providing a mobile application storable in relation to, and configuring, each piece of medical equipment of the plurality of medical equipment to individually communicate with the network device, providing the mobile application comprising providing a set of executable instructions for automatically collecting usage data in relation to each piece of medical equipment of the plurality of medical equipment and for automatically transmitting the usage data to the network device; and providing a processor configured to receive the usage data from the network device and to generate billing data based on the usage data corresponding to each piece of medical equipment of the plurality of medical equipment.

In accordance with an embodiment of the present disclosure, a method of managing a plurality of medical equipment by way of a system using distributed ledgers comprises: providing the system, providing the system comprising: providing a network device configured to communicate with the plurality of medical equipment; providing a mobile application storable in relation to, and configuring, each piece of medical equipment of the plurality of medical equipment to individually communicate with the network device, providing the mobile application comprising providing a set of executable instructions for automatically collecting usage data in relation to each piece of medical equipment of the plurality of medical equipment and for automatically transmitting the usage data to the network device; and providing a processor configured to receive the usage data from the network device and to generate billing data based on the usage data corresponding to each piece of medical equipment of the plurality of medical equipment; scanning an image by way of each piece of medical equipment, thereby providing a scan record and usage data corresponding to the image; storing at least one imaging parameter, corresponding to the image, in relation to an informatics system; automatically collecting usage data in relation to each piece of medical equipment of the plurality of medical equipment; automatically transmitting the usage data to the network device; receiving the usage data by the processor from the network device; and generating the billing data by the processor.

Some of the features in the present disclosure are broadly outlined in order that the section, entitled Detailed Description, is better understood and that the present contribution to the art by the present disclosure is better appreciated. Additional features of the present disclosure are described hereinafter. In this respect, understood is that the present disclosure is not limited in its implementation to the details of the components or steps as set forth herein or as illustrated in the several figures of the Drawing, but are capable of being carried out in various ways which are also encompassed by the present disclosure. Also, understood is that the phraseology and terminology employed herein are for illustrative purposes in the description and are not regarded as limiting.

### BRIEF DESCRIPTION OF THE DRAWING

The above, and other, aspects, and features, of the several embodiments in the present disclosure will be more apparent from the following Detailed Description as presented in conjunction with the following several figures of the Drawing.

FIG. 1 is a block diagram illustrating a system for managing a plurality of medical equipment via distributed ledgers, in accordance with an embodiment of the present disclosure.

FIG. 2 is a flow diagram illustrating a method of fabricating a system for managing a plurality of medical equipment via distributed ledgers, in accordance with an embodiment of the present disclosure.

FIG. 3A is a flow diagram illustrating a method of managing a plurality of capital equipment by way of a system using distributed ledgers, in accordance with an embodiment of the present disclosure.

FIG. 3B is a continued flow diagram illustrating a method of managing a plurality of capital equipment by way of a system using distributed ledgers, as shown in FIG. 3A, in accordance with an embodiment of the present disclosure.

Corresponding reference numerals or characters indicate corresponding components throughout the several figures of the Drawing. Elements in the several figures are illustrated for simplicity and clarity and have not necessarily been drawn to scale. For example, the dimensions of some elements in the figures are emphasized relative to other elements for facilitating understanding of the various presently disclosed embodiments. Also, well-understood elements that are useful or necessary in commercially feasible embodiment are often not depicted to facilitate a less obstructed view of these various embodiments of the present disclosure.

### DETAILED DESCRIPTION

The systems and methods described herein are useful in the field of imaging, such as used in relation to neurosurgery, including oncological care, neurodegenerative disease, stroke, brain trauma, and orthopedic surgery. The subject matter of the present disclosure is applicable to imaging in relation to other conditions or fields of medicine.

Various example apparatuses or processes are below-described. No below-described example embodiment limits any claimed embodiment; and any claimed embodiments may cover processes or apparatuses that differ from those examples described below. The claimed embodiments are not limited to apparatuses or processes having all the features of any one apparatus or process below described or to features common to multiple or all the apparatuses or processes below described. The claimed embodiments optionally comprise any of the below described apparatuses or processes.

Furthermore, numerous specific details are set forth in order to provide a thorough understanding of the disclosure. However, understood is that the embodiments described herein are practiced without these specific details. In other instances, well-known methods, procedures and components have not been described in detail so as not to obscure the embodiments described herein.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” or “example” means “serving as an example, instance, or illustration,” and should not be construed as preferred or advantageous over other configurations disclosed herein.

As used herein, the terms “about,” “approximately,” and “substantially” are meant to cover variations that may exist in the upper and lower limits of the ranges of values, such as variations in properties, parameters, and dimensions. In one non-limiting example, the terms “about,” “approximately,” and “substantially” are understood to mean plus or minus 10 percent or less.

Unless defined otherwise, all technical and scientific terms used herein are intended to have the same meaning as understood by one of ordinary skill in the art.

In embodiments of the present disclosure, the system and methods reduce technology adoption barriers for magnet resonance (MR) device by managing smart contracts within a MR-networked private blockchain for implementing a pay-per-use model in relation to capital equipment, such as the MR machine and other high-value capital equipment. The smart contract system and methods facilitate transactions between a lessor, such as an owner of capital equipment, and a lessee, such as a customer, e.g., a hospital and/or a medical imaging provider, wherein the lessee transmits payment for imaging services via a service contract comprising a pay-per-scan plan provision, and wherein the lessor receives payment for the imaging services, and wherein ownership of the capital equipment is retained by the lessor.

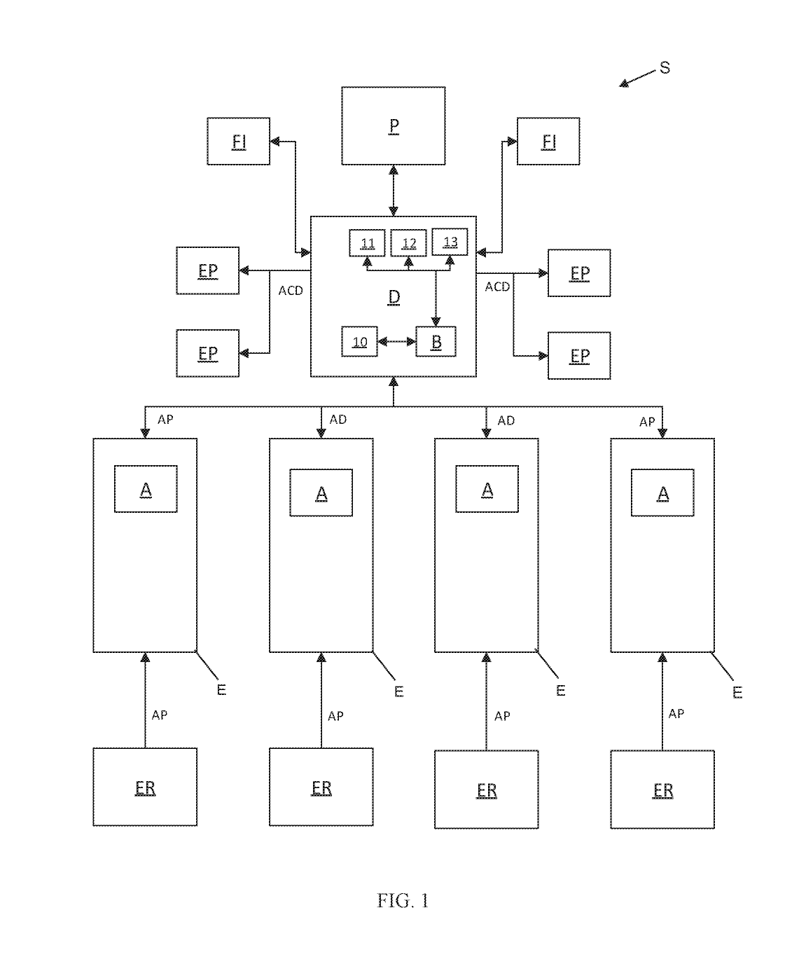

Referring to FIG. 1, this block diagram illustrates a system S for managing a plurality of medical equipment E via distributed ledgers and comprises: a network device D configured to communicate with the plurality of medical equipment E; a mobile application A storable in relation to, and configuring, each piece of medical equipment E of the plurality of medical equipment E to individually communicate with the network device D, the mobile application A comprising a set of executable instructions (not shown) for automatically collecting usage data (not shown) in relation to each piece of medical equipment E of the plurality of medical equipment E and for automatically transmitting the usage data (not shown) to the network device D; and a processor P configured to receive the usage data (not shown) from the network device D and to generate billing data (not shown) based on the usage data (not shown) corresponding to each piece of medical equipment E of the plurality of medical equipment E, in accordance with an embodiment of the present disclosure.

Still referring to FIG. 1, in the system S, the processor P is configured to automatically perform at least one contractual obligation by way of the network device D, wherein the processor P is configured to automatically perform at least one contractual obligation comprising ownership retention of the plurality of medical equipment E by an equipment provider; and, for each use of each piece of medical equipment E of the plurality of medical equipment E, to perform one of: automatic payment AP by an equipment receiver ER via the network device D; and automatic collection of payment ACP by an equipment provider EP via the network device D. The system S is used for managing the plurality of medical equipment E comprising a plurality of medical imaging capital equipment. The plurality of medical imaging capital equipment may comprise a plurality of magnetic resonance imaging machines.

Still referring to FIG. 1, in the system S, the network device D comprises a networked private blockchain B, wherein the networked private blockchain B is configured to manage at least one of patient imaging data 10, patient electronic medical records 11, customer usage data 12, and customer billing data 13. Additionally, in the system S, the networked private blockchain B is configured to allow access by each corresponding fiscal intermediary FI to each corresponding ledger via a network key (not shown) provided with each corresponding use report (not shown). The networked private blockchain B is also configured to recognize at least one imaging parameter (not shown) providable by an informatics system. The at least one imaging parameter (not shown) comprises at least one of a scan type, a unique patient case identification, a patient location identification, a customer identification, a machine identification, a machine location identification, at least one service-related revenue code, a unique customer intermediary identification, or a usage date.

By example only, using the system S of the present disclosure involves the following workflow: (1) scanning a patient in an MRI machine; (2) storing at least one imaging parameter in an informatics system, wherein the at least one imaging parameter comprises at least one scan detail, such as a scan type, a patient case identification (ID), a patient location ID, a customer ID, a machine ID, a machine location ID, at least one service-related revenue code, a unique customer medical fiscal intermediary ID, a date, and the like, and recording the at least one imaging parameter in the blockchain, such as the Synaptive® blockchain, thereby providing at least one scan record; (3) verifying the at least one scan record in relation to a lessee/customer-specific smart contract and transmitting a service payment to the lessor/owner, such as Synaptive® Medical Inc., based on a current pricing model provision in relation to the lessee/customer-specific smart contract; (4) transmitting at least one customized, automated, and key-encrypted report/form to at least one of an FI or a customer administrator.

By example only, using the system S of the present disclosure involves the blockchain being networked within all Synaptive® MR machines or devices. Customers and FIs would have access to a ledger via keys provided in their respective reports/forms. The smart contract system of the present disclosure, comprising a Blockchain is configurable for managing patient imaging data and records. Benefits to the lessee/customer include, but are not limited to, (a) high resolution, immutable records of use cases for cost reporting, wherein any potential “ledger fudging” is eliminated, e.g., as in health insurance billing fraud that is a prevalent problem in the United States of America; and (b) automated cost-reporting to Medicare FIs, whereby operational cost is reduced through “learning” internal processes. Benefits to the lessor/owner include, but are not limited to, (a) consistent fund transfer, e.g., cashflow, wherein transactions between the lessee/customer and the lessor/owner are immediate, and wherein funds consistently and reliably transfer from lessee to lessor by way of each and every machine or device that is connected to the smart contract system; and (b) providing valuable statistics in relation to machine or device use across a fleet of such machines or devices, e.g., for building high-resolution cost models for customers along all stages of a sales “funnel,” wherein the sales funnel refers to customers from qualified prospects to customers which have closed deals.

By example only, using the system S of the present disclosure facilitates the management of IoT (Internet of Things) medical imaging technologies and unlocks excess revenue capacity of a lessor's physical assets, e.g., capital medical equipment. The smart contract system is further configurable to use a payment model that enables a lessor to charge a fee for service premiums for “by-wire” upgrades in performance or for upgraded software features. In accordance with embodiments of the present disclosure, the smart contract system is implementable with systems, such as medical devices that are networkable for future automated software features, e.g. automated diagnostics features. Also, using the smart contract system of the present disclosure enables re-pricing of credit and risk, wherein the lessor may digitally manage risk and assess customer credit for additional products/services that are based on historical real-time asset performance data.

By example only, using the system S of the present disclosure provides at least the following benefits to legislators and administrators of federal healthcare organizations, e.g., Medicare): immutable, irrefutable, transparent, real-time, and high-resolution records in cost reporting that reduce bureaucratic waste; and reducing risk of system abuse, e.g., an ideal benefit due to tightening regulation to cut down on organized insurance fraud.

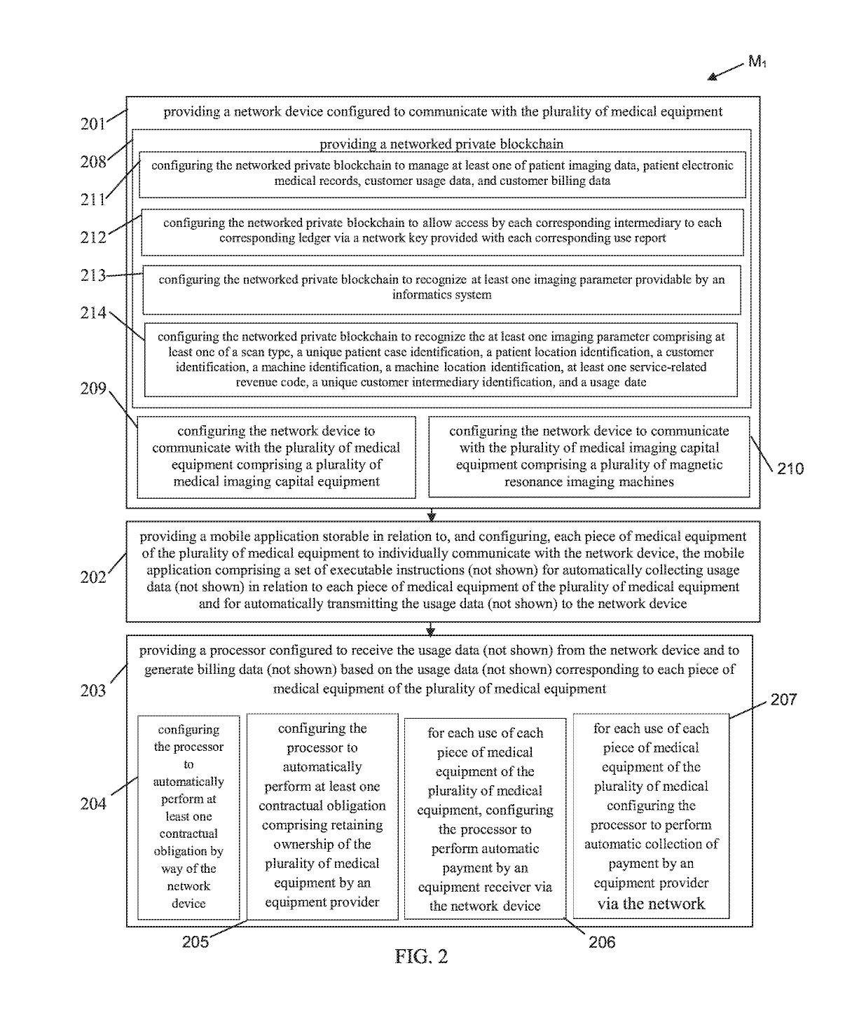

Referring to FIG. 2, this flow diagram illustrates a method M₁ of providing a system S for managing a plurality of medical equipment E via distributed ledgers and comprises: providing a network device D configured to communicate with the plurality of medical equipment E, as indicated by block 201; providing a mobile application A storable in relation to, and configuring, each piece of medical equipment E of the plurality of medical equipment E to individually communicate with the network device D, providing the mobile application A comprising providing a set of executable instructions (not shown) for automatically collecting usage data (not shown) in relation to each piece of medical equipment E of the plurality of medical equipment E and for automatically transmitting the usage data (not shown) to the network device D, as indicated by block 202; and providing a processor P configured to receive the usage data (not shown) from the network device D and to generate billing data (not shown) based on the usage data (not shown) corresponding to each piece of medical equipment E of the plurality of medical equipment E, as indicated by block 203, in accordance with an embodiment of the present disclosure.

Still referring to FIG. 2, in the method M₁, providing the processor P, as indicated by block 203, comprises configuring the processor P to automatically perform at least one contractual obligation by way of the network device D, as indicated by block 204. Also, providing the processor P, as indicated by block 203, comprises configuring the processor P to automatically perform at least one contractual obligation comprising retaining ownership of the plurality of medical equipment E by an equipment provider, as indicated by block 205; and, for each use of each piece of medical equipment E of the plurality of medical equipment E, configuring the processor P to perform one of: automatic payment by an equipment receiver via the network device D, as indicated by block 206; and automatic collection of payment by an equipment provider via the network device D, as indicated by block 207.

Still referring to FIG. 2, in the method M₁, providing the network device D, as indicated by block 201, comprises providing a networked private blockchain B, as indicated by block 208. Providing the network device D, as indicated by block 201, comprises configuring the network device D to communicate with the plurality of medical equipment E comprising a plurality of medical imaging capital equipment E, as indicated by block 209. Providing the network device D, as indicated by block 201, comprises configuring the network device D to communicate with the plurality of medical imaging capital equipment comprising a plurality of magnetic resonance imaging machines, as indicated by block 210.

Still referring to FIG. 2, in the method M₁, providing the networked private blockchain B, as indicated by block 208, comprises configuring the networked private blockchain B to manage at least one of patient imaging data, patient electronic medical records, customer usage data, and customer billing data, as indicated by block 211. Providing the networked private blockchain, as indicated by block 208, comprises configuring the networked private blockchain to allow access by each corresponding intermediary to each corresponding ledger via a network key provided with each corresponding use report, as indicated by block 212. Providing the networked private blockchain B, as indicated by block 208, comprises configuring the networked private blockchain B to recognize at least one imaging parameter providable by an informatics system, as indicated by block 213. Providing the networked private blockchain B, as indicated by block 208, comprises configuring the networked private blockchain B to recognize the at least one imaging parameter comprising at least one of a scan type, a unique patient case identification, a patient location identification, a customer identification, a machine identification, a machine location identification, at least one service-related revenue code, a unique customer intermediary identification, or a usage date, as indicated by block 214.

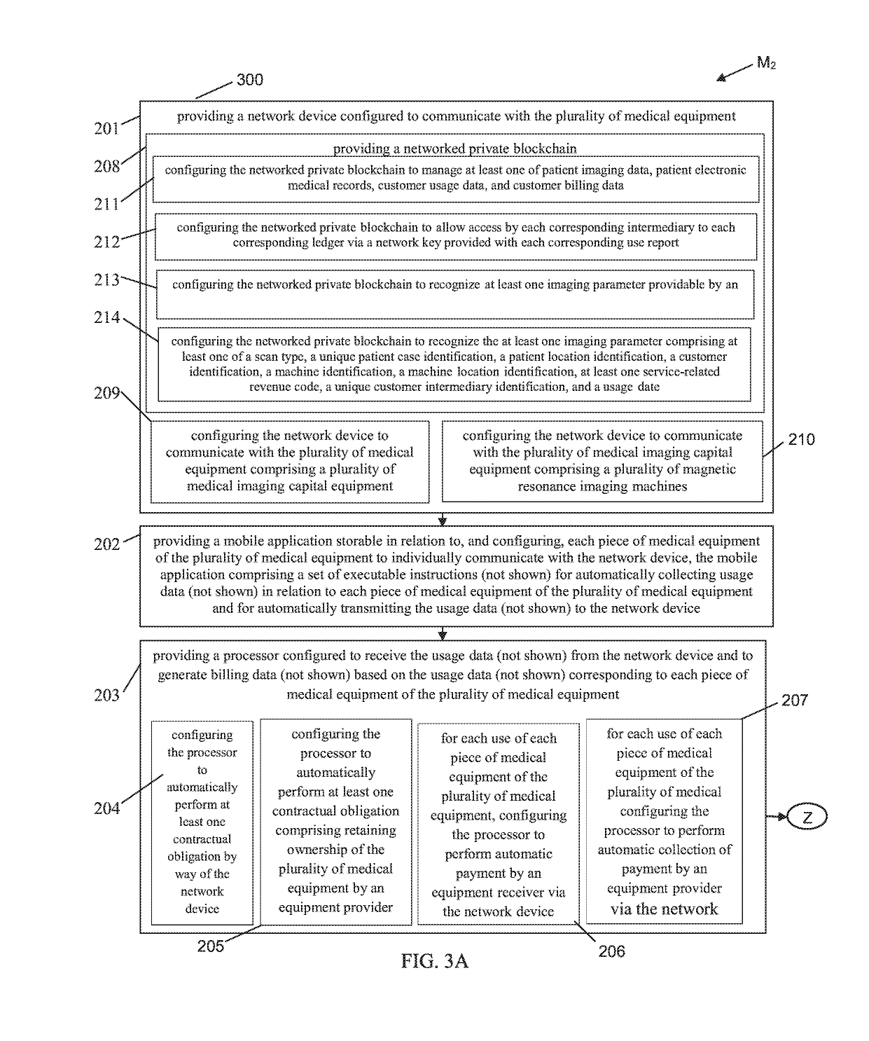

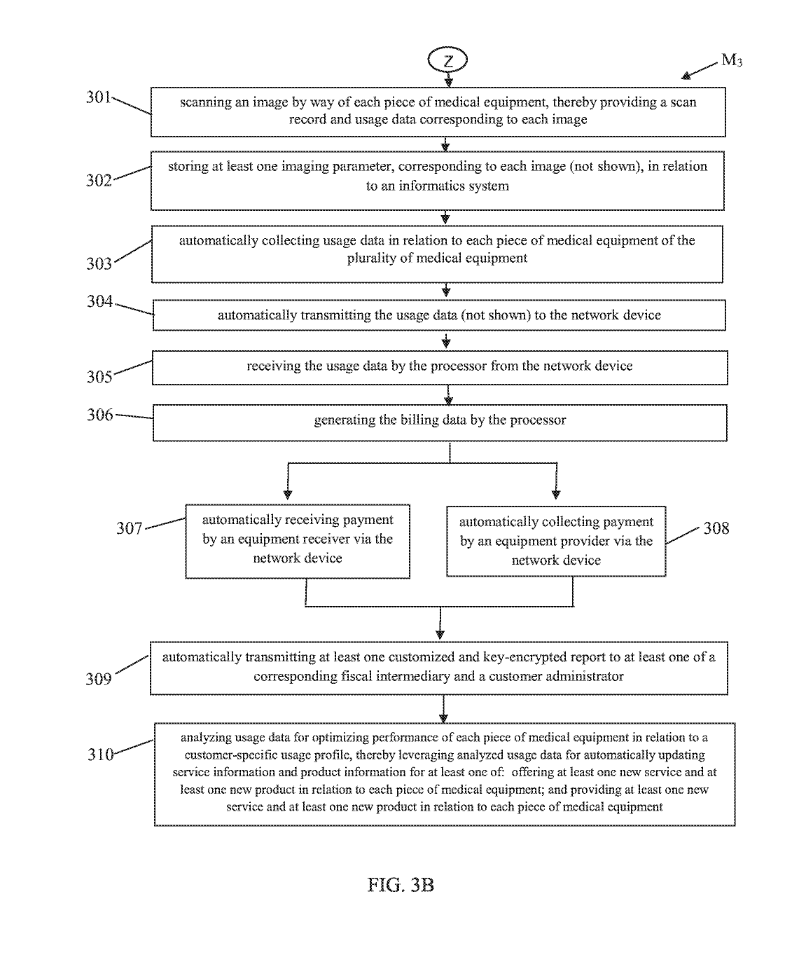

Referring to FIGS. 3A and 3B, together, these flow diagrams illustrate a method M₂ and M₃ of managing a plurality of medical equipment E by way of a system S via distributed ledgers. Note that FIG. 3B is a continuation of flow diagram FIG. 3A wherein element “Z” is the break-point that joins both diagrams. Methods M₂ and M₃ comprise of providing the system S, as indicated by block 300, providing the system S comprising: providing a network device D configured to communicate with the plurality of medical equipment E, as indicated by block 201; providing a mobile application A storable in relation to, and configuring, each piece of medical equipment E of the plurality of medical equipment E to individually communicate with the network device D, providing the mobile application A comprising providing a set of executable instructions (not shown) for automatically collecting usage data (not shown) in relation to each piece of medical equipment E of the plurality of medical equipment E and for automatically transmitting the usage data (not shown) to the network device D, as indicated by block 202; and providing a processor P configured to receive the usage data (not shown) from the network device D and to generate billing data (not shown) based on the usage data (not shown) corresponding to each piece of medical equipment E of the plurality of medical equipment E, as indicated by block 203; scanning an image (not shown) by way of each piece of medical equipment E, thereby providing a scan record (not shown) and usage data (not shown) corresponding to each image (not shown), as indicated by block 301; storing at least one imaging parameter (not shown), corresponding to each image (not shown), in relation to an informatics system I, as indicated by block 302; automatically collecting usage data (not shown) in relation to each piece of medical equipment E of the plurality of medical equipment E, as indicated by block 303; automatically transmitting the usage data (not shown) to the network device D, as indicated by block 304; receiving the usage data by the processor P from the network device D, as indicated by block 305; and generating the billing data by the processor P, as indicated by block 306, in accordance with an embodiment of the present disclosure.

Still referring to FIGS. 3A and 3B, together, the method M₃ further comprises one of: automatically receiving payment by an equipment receiver via the network device, as indicated by block 307; and automatically collecting payment by an equipment provider via the network device, as indicated by block 308. The method M₂ further comprises automatically transmitting at least one customized and key-encrypted report to at least one of a corresponding fiscal intermediary or a customer administrator, as indicated by block 309. The method M₃ further comprises analyzing usage data for optimizing performance of each piece of medical equipment in relation to a customer-specific usage profile, thereby leveraging analyzed usage data for automatically updating service information and product information for at least one of: offering at least one new service or at least one new product in relation to each piece of medical equipment; and providing at least one new service or at least one new product in relation to each piece of medical equipment, as indicated by block 310.

In a preferred embodiment, a system of managing a plurality of medical equipment via one or more distributed ledgers is disclosed. This system allows for micro-transactions to occur between, for example, the lessor or owner of capital medical equipment and the lessee or the customer (e.g., hospitals). This system will be useful to record and track micro-transactions of data. A physical device that has a network connection to the internet may benefit from this connected system to track usage data and payment details.

In the preferred embodiment, this system describes the use of blockchain concepts to support billing and use of capital medical equipment. However, the use of this system can be extended to support micro-transactions for use of other devices and applications. For example, this system can be extended to support using micro-transactions to track payment for services rendered by other cyber-physical devices.

In an alternate embodiment, the lessor or owner of capital medical equipment may utilize the system to validate the data for clinical research and research collaboration objectives. Further, the lessor may utilize this system to track usage of the capital medical equipment and assess return on investment (ROI). Other parties such as insurance companies, underwriters, hospital administration and business stakeholders may also tap into the system, collaborate, and share the data. For example, hospital administration may analyze the usage data of the capital medical equipment and delivery and services via the records on the system, assess the ROI of the capital medical equipment based on this data, and determine resource allocation accordingly.

In the preferred embodiment, the disclosure describes the use of the system for managing usage of MRI machines. However, any other medical equipment such as other medical capital equipment (ultrasound (US), x-ray, linear accelerators (LINAC), positron emission tomography (PET)), smart tools, surgical robots, navigation systems, and other imaging devices may be considered.

At least some aspects disclosed are embodied, at least in part, in software. That is, some disclosed techniques and methods are carried out in a computer system or other data processing system in response to its processor, such as a microprocessor, executing sequences of instructions contained in a memory, such as read-only memory (ROM), volatile random access memory (RAM), non-volatile memory, cache or a remote storage device.

A computer readable storage medium is used to store software and data which when executed by a data processing system causes the system to perform various methods or techniques of the present disclosure. The executable software and data is stored in various places including for example ROM, volatile RAM, non-volatile memory and/or cache. Portions of this software and/or data are stored in any one of these storage devices.

Examples of computer-readable storage media may include, but are not limited to, recordable and non-recordable type media such as volatile and non-volatile memory devices, ROM, RAM, flash memory devices, floppy and other removable disks, magnetic disk storage media, optical storage media, e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like. The storage medium is the internet cloud, or a computer readable storage medium such as a disc.

Furthermore, at least some of the methods described herein are capable of being distributed in a computer program product comprising a computer readable medium that bears computer usable instructions for execution by one or more processors, to perform aspects of the methods described. The medium is provided in various forms such as, but not limited to, one or more diskettes, compact disks, tapes, chips, universal server bus (USB) keys, external hard drives, wire-line transmissions, satellite transmissions, internet transmissions or downloads, magnetic and electronic storage media, digital and analog signals, and the like. The computer usable instructions may also be in various forms, including compiled and non-compiled code.

At least some of the elements of the systems described herein are implemented by software, or a combination of software and hardware. Elements of the system that are implemented via software are written in a high-level procedural language such as object-oriented programming or a scripting language. Accordingly, the program code is written in C, C++, J++, or any other suitable programming language and may comprise modules or classes, as is known to those skilled in object oriented programming. At least some of the elements of the system that are implemented via software are written in assembly language, machine language or firmware as needed. In either case, the program code can be stored on storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner for performing at least one of the methods described herein.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, any particular order to steps or stages of methods or processes described in this disclosure is not intended or implied. In many cases the order of process steps is varied without changing the purpose, effect, or import of the methods described.

Information as herein shown and described in detail is fully capable of attaining the above-described embodiments of the present disclosure and the presently preferred embodiment, if any, of the present disclosure, and is, thus, representative of the subject matter which is broadly contemplated by the present disclosure. The scope of the present disclosure fully encompasses other embodiments and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a device, an apparatus, a system, or a method to address each, and every, problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail is made, without departing from the spirit and scope of the present disclosure, as set forth in the appended claims, as is apparent, or may become apparent, to those of ordinary skill in the art, are also encompassed by the present disclosure.

### INDUSTRIAL APPLICABILITY

Generally, the present disclosure industrially applies to contract systems and methods. More particularly, the present disclosure industrially applies to electronic contract systems and methods. Even more particularly, the present disclosure industrially applies to smart contract systems and methods for use in managing capital medical equipment.

What is claimed:

1. A system for managing a plurality of medical equipment via distributed ledgers, the system comprising:
a network device configured to communicate with the plurality of medical equipment;
a mobile application storable in relation to, and configuring, each piece of medical equipment of the plurality of medical equipment to individually communicate with the network device, the mobile application comprising a set of executable instructions for automatically collecting usage data in relation to each piece of medical equipment of the plurality of medical equipment and for automatically transmitting the usage data to the network device; and
a processor configured to receive the usage data from the network device and to generate billing data based on the usage data corresponding to each piece of medical equipment of the plurality of medical equipment.

2. The system of claim 1, wherein the processor is configured to automatically perform at least one contractual obligation by way of the network device.

3. The system of claim 2, wherein the processor is configured to automatically perform at least one contractual obligation comprising ownership retention of the plurality of medical equipment by an equipment provider; and, for each use of each piece of medical equipment of the plurality of medical equipment, to perform one of:
automatic payment by an equipment receiver via the network device; or
automatic collection of payment by an equipment provider via the network device.

4. The system of claim 1, wherein the network device comprises a networked private blockchain.

5. The system of claim 1, wherein the plurality of medical equipment comprises a plurality of medical imaging capital equipment.

6. The system of claim 5, wherein the plurality of medical imaging capital equipment comprises a plurality of magnetic resonance imaging machines.

7. The system of claim 4, wherein the networked private blockchain is configured to manage at least one of patient imaging data, patient electronic medical records, customer usage data, or customer billing data.

8. The system of claim 4,
wherein the networked private blockchain is configured to allow access by each corresponding intermediary to each corresponding ledger via a network key provided with each corresponding use report,
wherein the networked private blockchain is configured to recognize at least one imaging parameter providable by an informatics system, and
wherein the at least one imaging parameter comprises at least one of a scan type, a unique patient case identification, a patient location identification, a customer identification, a machine identification, a machine location identification, at least one service-related revenue code, a unique customer intermediary identification, or a usage date.

9. A method of providing a system for managing a plurality of medical equipment via distributed ledgers, the method comprising:
providing a network device configured to communicate with the plurality of medical equipment;
providing a mobile application storable in relation to, and configuring, each piece of medical equipment of the plurality of medical equipment to individually communicate with the network device, providing the mobile application comprising providing a set of executable instructions for automatically collecting usage data in relation to each piece of medical equipment of the plurality of medical equipment and for automatically transmitting the usage data to the network device; and
providing a processor configured to receive the usage data from the network device and to generate billing data based on the usage data corresponding to each piece of medical equipment of the plurality of medical equipment.

10. The method of claim 9, wherein providing the processor comprises configuring the processor to automatically perform at least one contractual obligation by way of the network device.

11. The method of claim 10, wherein providing the processor comprises configuring the processor to automatically perform at least one contractual obligation comprising retaining ownership of the plurality of medical equipment by an equipment provider; and, for each use of each piece of medical equipment of the plurality of medical equipment, performing one of:
automatic payment by an equipment receiver via the network device; or
automatic collection of payment by an equipment provider via the network device.

12. The method of claim 9, wherein providing the network device comprises providing a networked private blockchain.

13. The method of claim 9, wherein providing the network device comprises configuring the network device to communicate with the plurality of medical equipment comprising a plurality of medical imaging capital equipment.

14. The method of claim 9, wherein providing the network device comprises configuring the network device to communicate with the plurality of medical imaging capital equipment comprising a plurality of magnetic resonance imaging machines.

15. The method of claim 12, wherein providing the networked private blockchain comprises configuring the networked private blockchain to manage at least one of patient imaging data, patient electronic medical records, customer usage data, or customer billing data.

16. The method of claim 12,
wherein providing the networked private blockchain comprises configuring the networked private blockchain to allow access by each corresponding intermediary to each corresponding ledger via a network key provided with each corresponding use report,
wherein providing the networked private blockchain comprises configuring the networked private blockchain to recognize at least one imaging parameter providable by an informatics system, and
wherein providing the networked private blockchain comprises configuring the networked private blockchain to recognize the at least one imaging parameter comprising at least one of a scan type, a unique patient case identification, a patient location identification, a customer identification, a machine identification, a machine location identification, at least one service-related revenue code, a unique customer intermediary identification, or a usage date.

17. A method of managing a plurality of medical equipment by way of a system using distributed ledgers, the method comprising:
providing the system, providing system comprising:
providing a network device configured to communicate with the plurality of medical equipment;
providing a mobile application storable in relation to, and configuring, each piece of medical equipment of the plurality of medical equipment to individually communicate with the network device, providing the mobile application comprising providing a set of executable instructions for automatically collecting usage data in relation to each piece of medical equipment of the plurality of medical equipment and for automatically transmitting the usage data to the network device; and
providing a processor configured to receive the usage data from the network device and to generate billing data based on the usage data corresponding to each piece of medical equipment of the plurality of medical equipment;
scanning an image by way of each piece of medical equipment, thereby providing a scan record and usage data corresponding to each image;
storing at least one imaging parameter, corresponding to each image, in relation to an informatics system;
automatically collecting usage data in relation to each piece of medical equipment of the plurality of medical equipment;
automatically transmitting the usage data to the network device;
receiving the usage data by the processor from the network device; and
generating the billing data by the processor.

18. The method of claim 17, further comprising one of:
automatically receiving payment by an equipment receiver via the network device; or
automatically collecting payment by an equipment provider via the network device.

19. The method of claim 17, further comprising automatically transmitting at least one customized and key-encrypted report to at least one of a corresponding fiscal intermediary or a customer administrator.

20. The method of claim 17, further comprising analyzing usage data for optimizing performance of each piece of medical equipment in relation to a customer-specific usage profile, thereby leveraging analyzed usage data for automatically updating service information and product information for at least one of:
offering at least one new service and at least one new product in relation to each piece of medical equipment; or
providing at least one new service and at least one new product in relation to each piece of medical equipment.
